(19) United States
(12) Patent Application Publication
(10) Pub. No.: US 2026/0365101 A1
(43) Pub. Date: Nov. 19, 2026

(54) LIGHTING ARRANGEMENT FOR A VEHICLE AND METHOD FOR OPERATING A LIGHTING ARRANGEMENT

(71) Applicant: Volkswagen Aktiengesellschaft, Wolfsburg (DE)

(72) Inventors: Bernhard KREIPE, Wolfsburg (DE); Sebastian LAMPE, Wolfsburg (DE); Alexander THIEL, Wolfsburg (DE)

(73) Assignee: Volkswagen Aktiengesellschaft, Wolfsburg (DE)

(21) Appl. No.: 19/682,031

(22) Filed: May 19, 2026

(30) Foreign Application Priority Data
May 19, 2025 (EP) 25177401.4

(51) Int. Cl. B60Q 1/08; B60Q 1/16; F21S 41/153; F21S 41/65; F21W 102/135; F21W 102/17

(52) U.S. Cl. CPC B60Q 1/085; B60Q 1/16; F21S 41/153; F21S 41/65; B60Q 2300/054; F21W 2102/135; F21W 2102/17

(57) ABSTRACT

A lighting arrangement for a vehicle comprising two headlights and a control device. Each of the headlights comprises exclusively one high-resolution light module and one additional light module each as light sources for generating a low beam and/or high beam distribution. The additional light module comprises exclusively one, two or three lighting elements. Each of the lighting elements and each of the high-resolution light modules is designed to illuminate a specified illumination area in front of the lighting arrangement. A first of the lighting elements is designed to illuminate the illumination area of a low beam. The control device is configured to control, depending on the operating state, the lighting elements and/or light points in such a way that the respective illumination area of a low beam and/or a cornering light and/or a high beam and/or a partial high beam is illuminated and/or a high-resolution projection is provided.

This nonprovisional application claims priority under 35 U.S.C. § 119(a) to European Patent Application No. 25177401.4, which was filed on May 19, 2025, and which is herein incorporated by reference.

### BACKGROUND OF THE INVENTION

### Field of the Invention

The invention relates to a lighting arrangement for a vehicle and a method for operating a lighting arrangement.

### Description of the Background Art

Vehicles, especially motor vehicles, are generally equipped with headlights that are designed to provide various light functions, such as a low beam and/or a high beam. The headlights of modern vehicles often comprise a large number of complex light modules, such as high-resolution light modules or bi-matrix modules, each with a large number of individually controllable lighting elements. Due to a large number of controllable lighting elements, the light modules can provide special lighting functions. However, modern headlight arrangements are relatively complex due to the large number of different light modules and/or lighting elements and result in relatively high costs.

Lighting arrangements are known, for example, from DE 10 2007 060 399 A1, US 11 585 509 B2, WO 2024/261000 A1 and EP 3 650 744 A1.

### SUMMARY OF THE INVENTION

It is therefore an object of the invention to improve a lighting arrangement for a vehicle and a method for operating a lighting arrangement, in particular with a view to a simpler design, wherein the solution is in particular provided to provide a wide variety of possible lighting functions.

In particular, a lighting arrangement for a vehicle is created, comprising two headlights and a control device, wherein each of the headlights comprises only one high-resolution light module and one additional light module each as light sources for the generation of a low beam and/or high beam distribution, wherein the high-resolution light module comprises light points arranged in a grid that can be controlled individually and/or in groups, wherein the additional light module comprises only one, two or three lighting elements, each of which can only be controlled as a whole, wherein each of the lighting elements and each of the high-resolution light modules is designed to illuminate a specified illumination area before the lighting arrangement, wherein the first of the lighting elements is designed to illuminate the illumination area of a low beam, and wherein the control device is set up to control the lighting elements and/or light points depending on the operating state in such a way that the respective illumination area of a low beam and/or a cornering light and/or a high beam and/or a partial high beam is illuminated and/or a high-resolution projection is provided.

Furthermore, in particular, a method for operating a lighting arrangement for a vehicle is provided, comprising: Operating two headlights by means of a control device, wherein each of the headlights comprises, as light sources for the generation of a low beam and/or high beam distribution, exclusively one high-resolution light module each with light points arranged in a grid and one additional light module each with only one, two or three lighting elements, wherein the lighting elements can only be controlled as a whole, wherein each of the lighting elements and each of the high-resolution light modules is equipped to illuminate a specified illumination area in front of the lighting arrangement, wherein the first of the lighting elements is set up to illuminate the illumination area of a low beam and wherein, depending on the operating state, the control device is set up to control the lighting elements and/or light points in such a way that the respective illumination area of a low beam and/or a cornering light and/or a high beam and/or a partial high beam is illuminated and/or a high-resolution projection is provided.

Furthermore, a method for operating a lighting arrangement for a vehicle is provided, comprising: operating two headlights by means of a control device, wherein each of the headlights comprises as light sources for generating a low beam and/or high beam distribution exclusively one high-resolution light module with light points arranged in a grid and one additional light module with exclusively one, two or three lighting elements, wherein the lighting elements can each be controlled exclusively as a whole, wherein each of the lighting elements and each of the high-resolution light modules is configured to illuminate a predetermined illumination area in front of the lighting arrangement, wherein a first of the lighting elements is configured to illuminate the illumination area of a low beam, and wherein the lighting elements and/or the light points are controlled individually and/or in groups, depending on the operating state, so that the respective illumination area of a low beam and/or a cornering light and/or a high beam and/or a partial high beam is illuminated and/or a high-resolution projection is provided.

The lighting arrangement and the method make it possible to provide different lighting functions through the headlights and at the same time reduce the cost of the lighting arrangement as compared to the prior art. The lighting arrangement comprises two headlights and a control device. The headlights each comprise a high-resolution light module and an additional light module. The headlights may include other light sources, but these do not contribute to the generation of a low beam and/or high beam distribution. The high-resolution light module comprises light points arranged in a grid, which can be controlled individually and/or in groups. The additional light module comprises only one, two or three lighting elements. The lighting elements can only be controlled as a whole. Each of the lighting elements and each of the high-resolution light modules is designed to illuminate a specified illumination area in front of the lighting arrangement. A first of the lighting elements is designed to illuminate the illumination area of a low beam. The control device controls the light points and/or the lighting elements depending on the operating state. Depending on the operating state, this illuminates a specified illumination area of a low beam and/or a cornering light and/or a high beam and/or a partial high beam and/or provides a high-resolution projection.

A basic idea of the invention is to provide a high-resolution light module in each of the headlights and to reduce the number of additional light sources. In each of the headlights, an additional light module is provided in addition to the high-resolution light module. The high-resolution light module and the additional light module are designed to work together to produce a low beam and/or high beam distribution. The headlights do not include any other light sources that contribute to the generation of low beam and/or high beam distribution. The additional light module comprises one, two or three lighting elements, which can only be controlled as a whole. The additional light module is therefore structurally simpler from a technical standpoint than comparable light sources from the state of the art, as it has a maximum of three lighting elements, which can only be controlled as a whole. This can reduce costs in particular. By controlling the headlights in a targeted manner, it is possible to illuminate all specified illumination areas in particular despite the simplified design. In particular, the required luminous intensity is provided by controlling the light modules in all illumination areas. As a result, a wide variety of lighting functions can be provided despite reduced costs. Furthermore, the high-resolution light modules in particular enable to selectively exclude (mask) specific areas from an image.

The lighting arrangement is provided to be used in a vehicle, in particular a motor vehicle.

The lighting arrangement can comprise two headlights. A headlight is in particular a luminaire which provides light in particular in one main lighting direction. As light sources, each headlight comprises two light modules. In particular, the light sources provide light required for the fulfilment of specified light functions. The light sources are in particular light modules or parts of a light module, such as a lighting element. The headlights are arranged in particular at the front of the vehicle. Furthermore, one of the headlights is arranged in particular on the left side of the front of the vehicle and another of the headlights on the right side of the front of the vehicle.

Each of the headlights can comprise a high-resolution light module as a light source. The high-resolution light module comprises a large number of light points. In particular, the high-resolution light module comprises more than 1000 light points, preferably more than 4000 light points. The light points can be controlled individually or in groups. The light points are arranged in a grid. In particular, the light points can be provided by mirroring a Digital Micromirror Device (DMD), by means of pixels of a liquid-crystal display (LCD) or by means of light-emitting diodes (LEDs), in particular by means of micropixelated LEDs or micro-LEDs.

In addition, each of the headlights comprises an additional light module as a light source. The additional light module comprises only one, two or three lighting elements as light sources. A first of the lighting elements is designed to illuminate an illumination area of a low beam. In particular, each lighting element comprises at least one light-emitting diode and/or at least one halogen lamp.

In particular, it may be provided that the headlights include other light sources that do not contribute to the generation of low beam and/or high beam distribution, such as a cornering light module.

An illumination area can be a solid angle or a set of solid angles in front of the lighting arrangement. In particular, the illumination area is illuminated by at least one light source or at least one light source is equipped to illuminate the illumination area. In particular, the illumination area of a light source is the solid angle that is illuminated by the light source when all controllable parts of the light source are active. In particular, the illumination area of a light function is the provided solid angle that must be illuminated in order to fulfil the light function. A lighting function can comprise several partial light functions, which together provide an overall light distribution. By controlling the lighting elements and/or light points depending on the operating state, a specified illumination area or a partial area thereof can be illuminated. In particular, various lighting functions can be made possible. In particular, by deactivating certain light points and/or lighting elements, a solid angle area can remain unilluminated, even if it is surrounded by illumination areas. In particular, this can provide masked light functions. In particular, the illumination area can be changed by specifically controlling the light points in such a way that a difference from the previous operating state is not perceptible to human vision, or only with difficulty. In particular, this can enable a continuous change of the illumination area. In particular, dynamic lighting functions can be provided in this way.

In this context,the operating state corresponds in particular to the provision of a lighting function or a combination of several partial lighting functions. In particular, the operating state specifies a control parameter for each controllable component of the light sources, which corresponds to a respective brightness value of the controllable component. In particular, a set of control parameters is stored for each operating state, in particular in the control device, and can be called up according to the desired operating state.

In particular, a low beam is a light function that illuminates an area directly in front of the lighting arrangement. In particular, the low beam is used to illuminate the road in front of a vehicle in which the lighting arrangement is installed. In particular, the illumination area of the low beam is below a horizontal plane passing through at least one of the headlights. In particular, the illumination area of the low beam is below a specified light/dark boundary. In particular, the light/dark boundary is a predetermined boundary above which blinding other road users is avoided. In particular, the area in front of the headlights is a part of the low beam that is below the light/dark boundary.

A cornering light can be a light function that illuminates an area diagonally in front of the lighting arrangement. In particular, the cornering light illuminates the roadway diagonally in front of a vehicle in which the lighting arrangement is installed. In particular, the cornering light expands the illuminated field of vision when the vehicle is turning toward a curve. The cornering light can be a dynamic or a static cornering light in particular.

A high beam can be a light function that illuminates an area in front of the lighting arrangement. In particular, the high beam serves to improve a driver's view over a distance that exceeds the illumination area of the low beam. In particular, the high beam is used to illuminate the road and/or traffic signs. In particular, the high beam is provided exclusively by the high-resolution light modules or by the high-resolution light modules in conjunction with the second lighting elements of the additional light modules. The illumination areas of the high-resolution light modules and the illumination areas of the second lighting elements of the additional light modules, if any, provide at least part of the illumination area of the high beam. In particular, the illumination area of the high beam is at least partially above the light-dark boundary. In particular, the high beam may be masked by controlling the light points in such a way that only a specified area in the illumination area of the high beam is illuminated, while another predetermined area in the illumination area of the high beam is masked. In particular, this can prevent blinding other road users without deactivating the high beam and without significantly reducing the driver's illuminated field of vision. In particular, this can provide a partial high beam (including glare-free high beam, continuous high beam or masked high beam). In particular, oncoming and/or preceding vehicles are detected by at least one sensor and/or at least one camera and the corresponding illumination areas that would lead to blinding of these vehicles are automatically masked by the control device.

In particular, a high-resolution projection can be a light function that provides a high-resolution light image on an area in front of the lighting arrangement, in particular onto a horizontal area, such as the road in front of the vehicle. In particular, high-resolution projection can provide structures and/or symbols, such as notices or warnings, on the roadway.

Parts of the lighting arrangement, in particular the control device, may be designed individually or collectively as a combination of hardware and software, for example as program code executed on a computing device, in particular a microcontroller or microprocessor. However, it may also be provided that parts are individually or collectively designed as an application-specific integrated circuit (ASIC) and/or field-programmable gate field (FPGA) and/or graphics processor (GPU) and/or digital signal processor (DSP). In particular, the control device may comprise at least one computing device and at least one memory.

A second of the lighting elements of the additional light module can be designed to illuminate an illumination area of a high beam. In particular, this can increase the luminous intensity of the high beam or provide part of the luminous intensity of the high beam from the second lighting element.

A third of the lighting elements of the additional light module can be designed to illuminate the illumination area of the low beam together with the first of the lighting elements, wherein the third of the lighting elements is designed to illuminate the central area of the area in front of the vehicle. In particular, this allows for segmented light distribution to be provided in front of the vehicle. In particular, a third lighting element may be provided even if there is no second lighting element.

The illumination area of the second lighting element of the additional light module can be larger than the illumination area of the high-resolution light module. In particular, this can provide a specified luminous intensity of the high beam, even if the illumination area of the high-resolution light module is smaller than an illumination area of the high beam. In particular, part of the high beam that lies outside the illumination area of the high-resolution light module can be provided by the additional light module. A smaller illumination area of the high-resolution light module also distributes a light output over a smaller solid angle. In particular, this can increase the luminous intensity of a resulting light image of the high-resolution light module. In particular, this can increase the contrast and/or resolution of the resulting light image.

The high-resolution light module can be designed to illuminate an illumination area that has a horizontal opening angle of at least 30° and a vertical opening angle of at least 8°. In particular, this allows for the illumination area of the high beam to be illuminated to a large extent by the high-resolution light module. In particular, this can increase the size of a maskable area.

The high-resolution light module can be designed to illuminate at least one illumination area that extends from -3.5° to +5° in relation to a horizontal plane. In particular, a portion of the illumination area above the horizontal plane allows for the illumination area of the high beam to be illuminated to a large extent by the high-resolution light module. A portion of the illumination area below the horizontal plane can also provide a high-resolution projection and/or illuminate a part of the illumination area of a low beam.

The high-resolution light module can be designed to illuminate an illumination area that has a horizontal opening angle of at least 40° and a vertical opening angle of at least 10°. In particular, this allows for the illumination area of the high beam to be completely illuminated by the high-resolution light module.

The respective high-resolution light modules and the respective second lighting elements of the additional light modules of the headlights can be designed to provide a high beam with a specified minimum luminous intensity on a pro rata basis. In particular, this makes it possible to comply with a legal requirement for the brightness of a high beam. In particular, it is provided that a minimum luminous intensity of 40000 cd must be provided. In particular, it is also provided that the high-resolution light modules are designed to provide a proportion of at least 50% of the luminous intensity of the high beam in an operating state in which all light points and lighting elements are active.

The respective high-resolution light modules can be designed to provide a high beam with a specified minimum luminous intensity. In particular, this makes it possible to comply with a legal requirement for the brightness of a high beam even in those examples in which no second lighting element of the additional light module is provided. In particular, it is provided that a minimum luminous intensity of 40000 cd is provided.

The second lighting element of the additional light module of at least one of the headlights can be designed to illuminate an illumination area that is horizontally asymmetrical with respect to a horizontal main lighting direction of the lighting arrangement. In particular, the illumination area of the second lighting element may be shifted towards one side of the lighting arrangement. In particular, the illumination area of a given size may also include those areas that are further away from the main illumination direction than would be the case with a symmetrical illumination area. In particular, the illumination area of the second lighting element can thus be better adapted to a given lighting function.

The respective illumination area of the second lighting element of the additional light module of at least one of the headlights can be shifted towards an outer side of the lighting arrangement as compared to towards a symmetrical illumination area. In particular, this can reduce an overlap between the illumination areas of the headlights. In particular, this can increase an entire illumination area of the lighting arrangement.

The high-resolution light module of at least one of the headlights can be designed to illuminate an illumination area that is horizontally asymmetrical with respect to a horizontal main lighting direction of the lighting arrangement. In particular, the illumination area of the high-resolution light module may be shifted towards one side of the lighting arrangement. In particular, the illumination area of a given size may also include those areas that are further away from the main illumination direction than would be the case with a symmetrical illumination area. In this way, in particular, the illumination area of the high-resolution light module can be better adapted to a given lighting function.

The illumination area of the second lighting element of the additional light module can be smaller than the illumination area of the high-resolution light module, wherein the illumination area of the second lighting element of the additional light module is shifted towards one side of the lighting arrangement. In particular, this can increase an entire illumination area of the lighting arrangement. In particular, this reduces an area in which the illumination area of the high-resolution light source overlaps with the illumination area of the second lighting element of the additional light source. This allows for a maskable area of the lighting arrangement to be enlarged, especially in the main lighting direction.

The high-resolution light module and the additional light module can be designed to provide a high beam in at least one operating state, wherein a total light distribution of the operating state provided at a boundary between the illumination area of the high-resolution light module and the additional light module does not exceed a specified luminous intensity difference. In particular, this means that no boundary between the illumination area of the high beam and the illumination area of the low beam is perceptible to human vision. If the lighting arrangement is located in a vehicle, the driver's visibility in particular can be improved.

In addition, a vehicle is created in particular, comprising at least one lighting arrangement according to any of the examples described. In particular, the vehicle can be a motor vehicle, for example a passenger car or a truck.

Further features for the method result from the description of the lighting arrangement. The advantages of the method are the same in each case as for the examples of the lighting arrangement.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of an example of the lighting arrangement;

FIG. 2 shows a schematic representation of an example of the lighting arrangement;

FIG. 3 shows a schematic representation of an example of the lighting arrangement;

FIG. 4 shows a schematic representation of an example of the lighting arrangement;

FIG. 5 shows a schematic representation of an emerging light distribution of a symmetrical example of a headlight in an operating state in which all light points of the high-resolution light module are active;

FIG. 6 shows a schematic representation of the resulting light distribution of an asymmetrical example of a headlight in an operating state in which all light points of the high-resolution light module are active; and

FIG. 7 shows a schematic flow chart of an example of the method.

### DETAILED DESCRIPTION

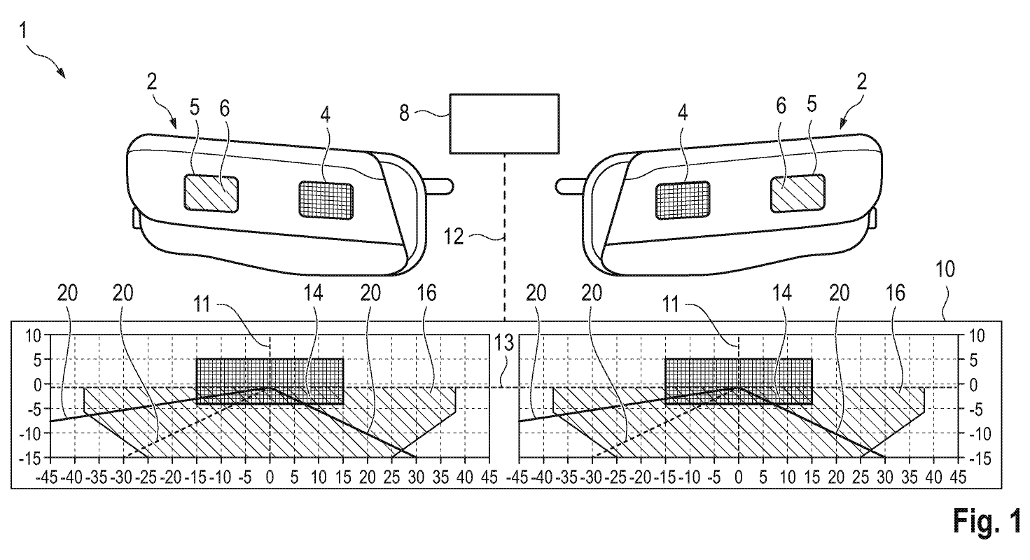

FIG. 1 shows a schematic representation of examples of the lighting arrangement 1. In the lower area of FIG. 1, a light distribution 10 is shown from a perspective of the respective headlight 2, which results on a vertical plane in front of the respective headlight 2, wherein the plane is perpendicular to a central plane 12 between the headlights 2. In other words, for each headlight 2, a light distribution is shown as it would be depicted on a wall in front of the lighting arrangement if all light sources were active. Since a quantity of the light distribution scales in all directions with a distance to the headlight 2, the representation is limited to angles with respect to a horizontal main lighting direction 11, which runs in particular parallel to the central plane 12 and through the respective headlight, and a horizontal plane (at 0°), which runs through the headlights 2. The horizontal main lighting direction 11 is in particular a horizontal directional part of a vehicle's longitudinal axis of a vehicle, which includes the lighting arrangement 1. In particular, a horizontal angle between the horizontal main lighting direction 11 and the central plane 12 is 0°. Furthermore, from the perspective of the respective headlight 2, lane boundaries 20 of a lane used by a vehicle in which the lighting arrangement 1 is arranged are schematically represented. Correspondingly, a lane boundary 20 of a lane adjacent to the left of the lane being driven in is also shown from the perspective of the respective headlight 2.

The lighting arrangement 1 comprises two headlights 2 and a control device 8. The headlights 2 each comprise a high-resolution light module 4 and an additional light module 5. The high-resolution light module 4 comprises light points arranged in a grid that can be controlled individually and/or in groups. In the example shown, the additional light module 5 comprises only a first lighting element 6. The first lighting element 6 can only be controlled as a whole. The lighting elements 6 and the high-resolution light modules 4 are designed to illuminate a specified illumination area 14, 16 in front of the lighting arrangement 1. The first lighting element 6 is designed to illuminate the illumination area of a low beam.

The control device 8 controls the light points and/or the lighting elements 6 depending on the operating state. Depending on the operating state, this illuminates a specified illumination area of a low beam and/or a cornering light and/or a high beam and/or provides a high-resolution projection.

In particular, it is provided that the illumination area of a low beam is below a light-dark boundary 13. In the example shown, the light-dark boundary 13 is in particular 1° below the horizontal plane. In particular, it is provided that the illumination area 16 of the first lighting element 6 at the light-dark boundary 13 includes a horizontal area extending from -38° to +38° with respect to the horizontal main lighting direction 11. Furthermore, it is provided in particular that the illumination area 16 of the first lighting element 6 covers a vertical area extending from the light-dark boundary 13 to -15° below the horizontal plane. In particular, it is provided that the illumination area 16 of the first lighting element 6 is angled outwards on a lower side, so that in particular a hexagonal shape results.

Furthermore, it is provided in particular that the illumination area 14 of the high-resolution light module 4 has a horizontal opening angle of at least 30° (from -15° to +15°) and a vertical opening angle of at least 8°.

In an example, it is provided in particular that the illumination area 14 of the high-resolution light module 4 extends from -3.5° to +5° with respect to a horizontal plane.

In an example, it is also provided that the respective high-resolution light modules 4 are designed to provide a high beam with a specified minimum luminous intensity.

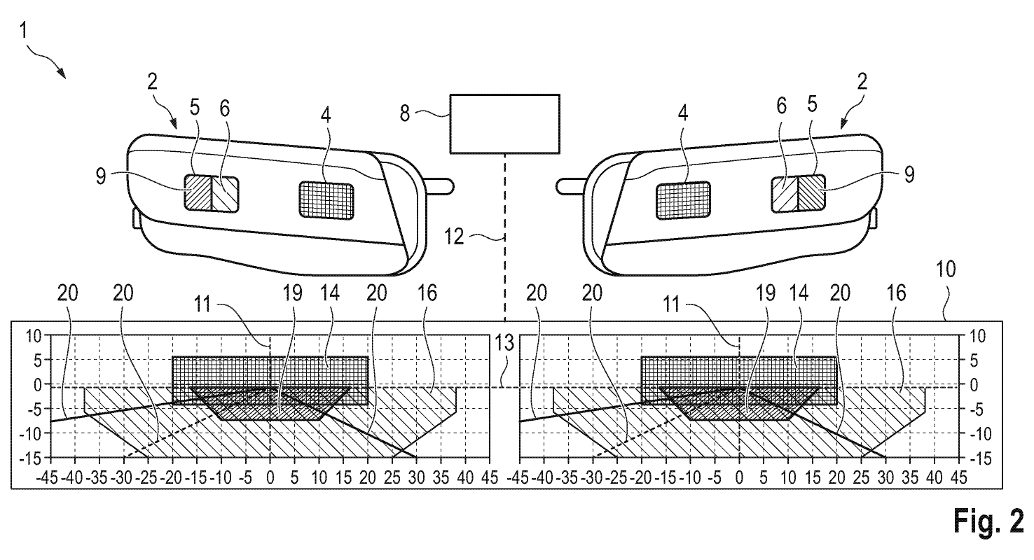

FIG. 2 shows a schematic representation of examples of the lighting arrangement 1. The example are basically designed in the same way as the example shown in FIG. 1. In one of the examples shown, it is provided that the illumination area 14 of the high-resolution light module 4 has a horizontal opening angle of at least 40° (from -20° to +20°) and a vertical opening angle of at least 10°.

Furthermore, the additional light module in another of the examples shown comprises only a first lighting element 6 and a third lighting element 9. The third of the lighting elements 9 of the additional light module 5 is designed to illuminate the illumination area of the low beam in conjunction with the first of the lighting elements 6, wherein the third of the lighting elements 9 is designed to illuminate a central area of the area in front of the vehicle. For this purpose, the illumination area 19 of the third of the lighting elements 9 is arranged at the horizontal main lighting direction 11 and at the light-dark boundary 13.

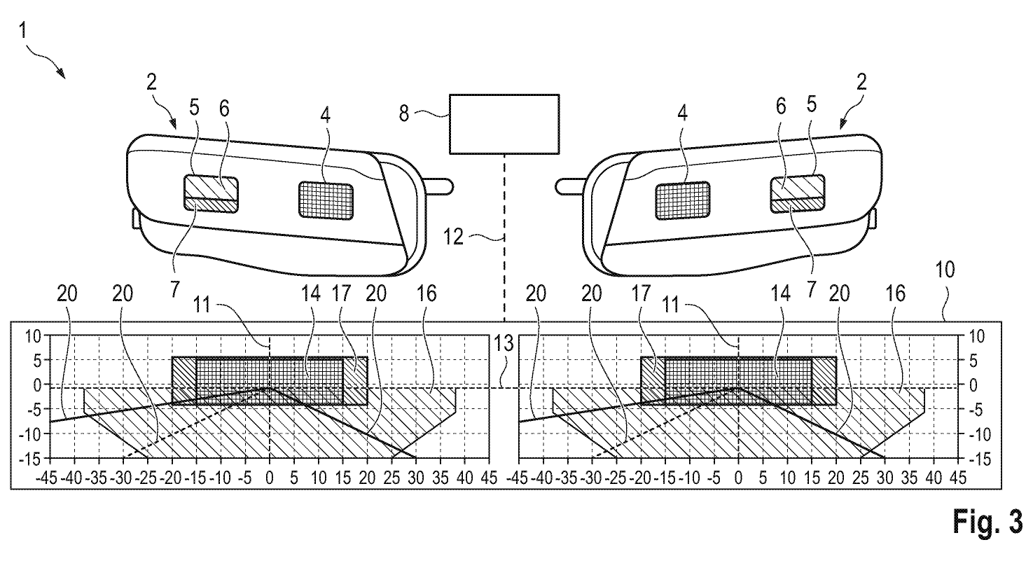

FIG. 3 shows a schematic representation of an example of the lighting arrangement 1. The example is basically designed in the same way as the example shown in FIG. 1. In the example shown, the additional light module 5 comprises only two lighting elements 6, 7. The lighting elements 6, 7 can only be controlled as a whole. Each of the lighting elements 6, 7 and each of the high-resolution light modules 4 is designed to illuminate a specified illumination area 14-17 in front of the lighting arrangement 1. The second lighting element 7 is designed to illuminate an illumination area of a high beam. In particular, it is provided that the illumination area 17 of the second lighting element 7 of the additional light module 5 is larger than the illumination area 14 of the high-resolution light module 4. Furthermore, it is provided in particular that the respective high-resolution light modules 4 and the respective second lighting elements 7 of the additional light modules 5 of the headlights 2 are each set up to provide a high beam with a specified minimum luminous intensity on a pro rata basis. In particular, it is provided that a minimum luminous intensity of 40000 cd is provided. In particular, it is also provided that the high-resolution light modules 4 are designed to provide a proportion of at least 50% of the luminous intensity of the high beam in an operating state in which all light points and lighting elements 6, 7 are active. In the example shown, it is provided that the illumination area 17 of the second lighting element 7 has a horizontal opening angle of at least 40° (from -20° to +20°) and a vertical opening angle of at least 8°.

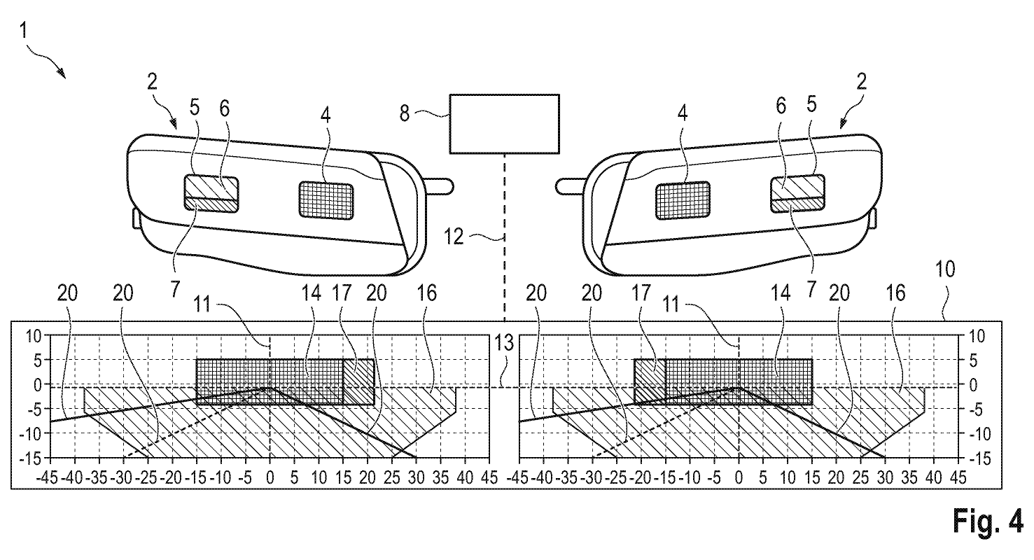

FIG. 4 shows a schematic representation of an example of the lighting arrangement 1. The example is basically the same as the example shown in FIG. 1. In the example shown, the illumination area 17 of the respective second lighting element 7 of the headlights 2 is horizontally asymmetrical with respect to the horizontal main lighting direction 11. In particular, it is provided that the respective illumination area 17 of the second lighting element 7 of the additional light module 5 of at least one of the headlights 2 is shifted towards the outside of the lighting arrangement as compared to a symmetrical illumination area. In particular, it is provided that an outer boundary of the illumination area 17 of the second lighting element 7 is arranged at an angle of at least 5° further in the direction of the outside of the lighting arrangement 1 than the outer boundary of the illumination area 14 of the high-resolution light module 4. In the example shown, it is provided that the illumination area 17 of the second lighting element 7 has a horizontal opening angle of at least 7° and a vertical opening angle of at least 8°. In particular, the second lighting element 7 is arranged in such a way that there is no gap between the illumination area 17 of the second lighting element 7 and the illumination area 14 of the high-resolution lighting element 4.

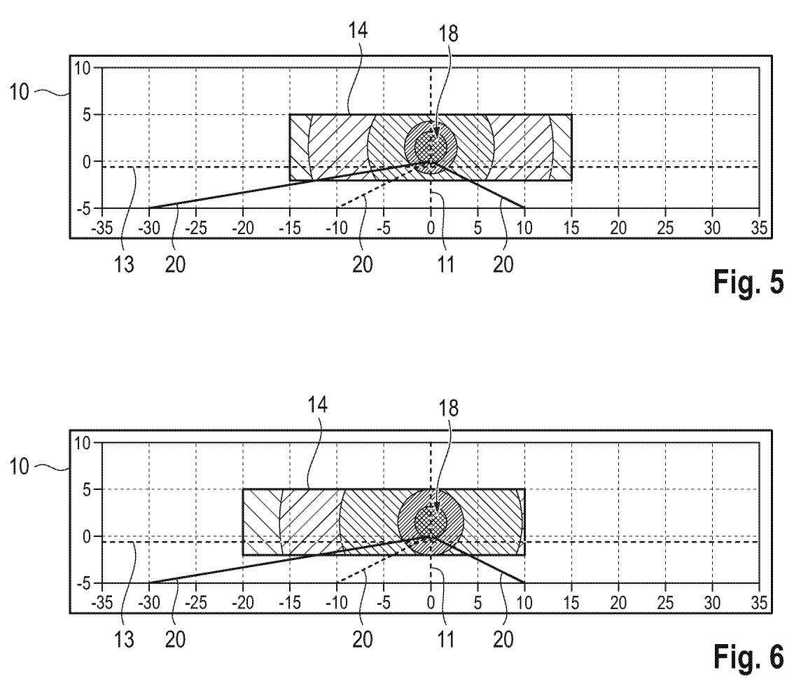

FIG. 5 shows a schematic representation of a light distribution 10 of a symmetrical example of a headlight in an operating state in which all light points of the high-resolution light module 4 are active. A light distribution 10 of the example depicted in FIG. 3 is shown. For all reference signs whose features are not shown in FIG. 5, reference is made to FIG. 3. In the example shown, the illumination area 14 of the respective high-resolution light module 4 is symmetrical with respect to the horizontal main lighting direction 11 of the lighting arrangement 1. In particular, in the operating state shown, a light distribution 10 is provided whose region of maximum luminous intensity 18 encompasses the horizontal main lighting direction 11 of the lighting arrangement 1.

FIG. 6 shows a schematic representation of a light distribution 10 of an asymmetrical example of a headlight in an operating state in which all light points of the high-resolution light module 4 are active. For all reference signs whose features are not shown in FIG. 6, reference is made to FIG. 4. In the example shown, the illumination area 14 of the high-resolution light module 4 is asymmetrical with respect to the horizontal main illumination direction 11 of the lighting arrangement 1. In particular, in the operating state shown, a light distribution 10 is provided, whose region of maximum luminous intensity 18 encompasses the horizontal main lighting direction 11 of the lighting arrangement 1.

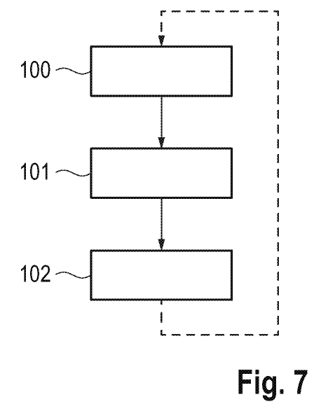

FIG. 7 shows a schematic flow chart of an example of the method. In a method step 100, an operating state is specified, for example by a vehicle control system. In a method step 101, the light modules and/or the light points and/or the lighting elements are controlled individually and/or in groups by means of the control device according to the operating state. In this way, a specified illumination area is illuminated and/or a high-resolution projection is provided in a method step 102. The specified illumination area can include the respective illumination area of a low beam and/or a cornering light and/or a high beam and/or overlap with it. The method is then performed again. If necessary, a modified operating state can be specified so that the control of the light modules and/or the light points and/or the lighting elements also changes, and thus also the resulting light distribution, if necessary.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A lighting arrangement for a vehicle, the lighting arrangement comprising:
two headlights; and
a control device,
wherein each of the headlights comprises exclusively one high-resolution light module and one additional light module, each as light sources for generating a low beam and/or high beam distribution,
wherein the high-resolution light module comprises light points arranged in a grid, controllable individually and/or in groups,
wherein the additional light module comprises only one, two or three lighting elements, each of which being adapted to be only controlled as a whole,
wherein each of the lighting elements and each of the high-resolution light modules is designed to illuminate a specified illumination area in front of the lighting arrangement,
wherein a first of the lighting elements is configured to illuminate the illumination area of a low beam, and
wherein the control device is configured to control, depending on the operating state, the lighting elements and/or light points such that the respective illumination area of a low beam and/or a cornering light and/or a high beam and/or a partial high beam is illuminated and/or a high-resolution projection is provided.

2. The lighting arrangement according to claim 1, wherein a second of the lighting elements of the additional light module is designed to illuminate an illumination area of a high beam.

3. The lighting arrangement according to claim 1, wherein a third of the lighting elements of the additional light module is designed to illuminate the illumination area of the low beam in conjunction with the first of the lighting elements, and wherein the third of the lighting elements is designed to illuminate a central area of the area in front of the vehicle.

4. The lighting arrangement according to claim 1, wherein the illumination area of the second lighting element of the additional light module is greater than the illumination area of the high-resolution light module.

5. The lighting arrangement according to claim 1, wherein the high-resolution light module is designed to illuminate an illumination area having a horizontal beam angle of at least 30° and a vertical beam angle of at least 8°.

6. The lighting arrangement according to claim 1, wherein the high-resolution light module is designed to illuminate at least one illumination area extending from -3.5° to +5° with respect to a horizontal plane.

7. The lighting arrangement according to claim 1, wherein the high-resolution light module is designed to illuminate an illumination area having a horizontal beam angle of at least 40° and a vertical beam angle of at least 10°.

8. The lighting arrangement according to claim 1, wherein the respective high-resolution light modules and the respective second lighting elements of the additional light modules of the headlights are designed to provide a high beam with a specified minimum luminous intensity on a pro-rata basis.

9. The lighting arrangement according to claim 1, wherein the respective high-resolution light modules are designed to provide a high beam with a specified minimum luminous intensity.

10. The lighting arrangement according to claim 1, wherein the second lighting element of the additional light module of at least one of the headlights is designed to illuminate an illumination area that is horizontally asymmetrical with respect to a horizontal main lighting direction of the lighting arrangement.

11. The lighting arrangement according to claim 10, wherein the respective illumination area of the second lighting element of the additional light module of at least one of the headlights is shifted towards the outside of the lighting arrangement as compared to a symmetrical illumination area.

12. The lighting arrangement according to claim 1, wherein the high-resolution light module of at least one of the headlights is designed to illuminate an illumination area which is horizontally asymmetrical with respect to a horizontal main illumination direction of the lighting arrangement.

13. The lighting arrangement according to claim 1, wherein the high-resolution light module and the additional light module are designed to provide a high beam in at least one operating state, wherein a provided total light distribution of the operating state at a boundary between the illumination area of the high-resolution light module and the additional light module does not exceed a predetermined difference in luminous intensity.

14. A vehicle comprising the lighting arrangement according to claim 1.

15. A method for operating a lighting arrangement for a vehicle, the method comprising:
providing two headlights; and
operating two headlights via a control device, wherein each of the headlights comprises, as light sources for generating low beam and/or high beam distribution, exclusively one high-resolution light module with light points arranged in a grid and one additional light module with exclusively one, two or three lighting elements,
wherein the lighting elements are only adapted to be controlled as a whole,
wherein each of the lighting elements and each of the high-resolution light modules is designed to illuminate a specified illumination area in front of the lighting arrangement,
wherein a first of the lighting elements is set up to illuminate the illumination area of a low beam, and
wherein the lighting elements and/or the light points, depending on the operating state are controlled individually and/or in groups, so that the respective illumination area
of a low beam and/or a cornering light and/or a high beam and/or a partial high beam and/or a high-resolution projection is provided.
